(19) United States
(12) Patent Application Publication
(10) Pub. No.: US 2007/0051391 A1
(43) Pub. Date: Mar. 8, 2007

(54) Stain removal kit, and method for removing stains

(76) Inventors: Scott S. Wolff, Windermere, FL (US); Gary L. Waymire, Menlo Park, CA (US); Michael R. Barry, Palo Alto, CA (US)

Correspondence Address: PETER L. BREWER BEARMAN, CALDWELL, & BERKOWITZ;LAW FIRM, 165 MADISON AVENUE, SUITE 2000, MEMPHIS, TN, 38103, US

(21) Appl. No.: 11/210,947

(22) Filed: Aug. 24, 2005

(51) Int. Cl. B08B 7/00

(52) U.S. Cl. 134/42; 510/439

(57) ABSTRACT

A stain removal kit that includes a pad impregnated with a substantially dry cleaning composition is provided. The pad is placed into a sealed, water-impermeable, sealable container. The pad is removable after opening and activating with warmed water. The pad may then be applied to fabric to remove a stain. A method for removing a stain from synthetic fibers is also disclosed. The method generally involves placing heated water into the container for a period of time to allow the pad to absorb the water and to create liquefied cleaning composition in the pad. The pad is then placed onto a stained area of a synthetic fabric for a period of time sufficient for the cleaning composition to act on the stain and the pad. The stain is thereby wicked away.

### BACKGROUND OF THE INVENTION

1. Field of the Invention

The present invention relates to the removal of stains. More specifically, the invention relates to a kit for the removal of stains and a method for stain removal.

2. Description of the Related Art

Many different types of products for cleaning fabrics are known. Such products most commonly define liquid surfactants that are either applied to a wiping cloth and then rubbed onto a stain for attempted removal, or applied directly to the stain and then rubbed with an pad. The pad may be a sponge, a brush or a rag. Such cleaning methods employ a frictional engagement between the stained fabric and the pad.

The use of friction to apply a surfactant or other cleaning composition to a fabric may harm the fabric itself. In addition, it is difficult to isolate the frictional application of the cleaning composition to the immediate area to be cleaned. In addition, the use of friction does not afford the surfactant a period of time to settle into the stain and loosen it from the fibers of the fabric.

In an effort to provide a more gentle method of cleaning, various dry cleaning compositions have been developed. However, many of these still require some application of friction to the stained area. Therefore, a need exists in the art for a pad that holds a cleaning composition that may be readily activated for removal of stains from fabrics. In addition, a need exists for a method for removing a stain that employs a pad holding an imbedded surfactant.

### SUMMARY OF THE INVENTION

A stain removal kit is first provided. In one embodiment, the kit includes a water impermeable container and a liquid-absorbent pad disposed within the container. The container may be, for example, a plastic bag or a plastic tray. The dry pad may be, for example, a swatch of cotton cloth. The pad is impregnated with a powdered cleaning composition in a substantially dry state before being placed in the container. The kit also includes a selectively opened sealing means for the container.

Various cleaning compositions may be gainfully applied to the pad. Preferably, the cleaning composition is an anhydrous paste comprised of a surfactant, a bleach and an enzyme. In one aspect, the surfactant is a nonionic, hydrophobic surfactant such as a linear alcohol ethoxylate. The bleach is preferably an oxygen bleach such as sodium percarbonate. The enzyme is preferably a dry prilled enzyme.

In another aspect, a method for removing stains from fabric is provided. In one aspect, the method includes the steps of providing a pad impregnated with a dry powder cleaning composition; storing the pad in a sealed container in its dry state; opening the container; applying heated water to the pad to produce at least a wetted portion of the pad; removing the pad from the container; placing the wetted portion of the pad onto a stained fabric; and leaving the pad on the fabric for a sufficient period of time to permit at least a portion of the stain to be removed from the fabric. In one aspect, the step of applying heated water to the pad comprises pouring heated water into the container; and allowing the pad to absorb heated water until it is fully saturated. Preferably, the pad remains on the stain until the pad is substantially dry.

### BRIEF DESCRIPTION OF THE DRAWINGS

Features, objects and advantages of the present inventions will be apparent upon reading the following detailed description in conjunction with reference to the appended drawings. It is to be noted, however, that the appended drawings illustrate only selected embodiments of the inventions and are therefore not to be considered limiting of scope, for the inventions may admit to other equally effective embodiments and applications.

FIG. 1 illustrates a perspective view of a stain removal kit of the present invention, in one embodiment.

FIG. 2 provides a perspective view of a stain removal kit of the present invention, in an alternate embodiment.

FIG. 3 shows a pad of the stain removal kit being applied onto a stained carpet.

### DETAILED DESCRIPTION

### Definitions

As used herein, the term “pad” refers to any water absorbent pad that has or can be formed to have a substantially planar surface. A non-limiting example is a swatch of cotton fabric.

The term “plastic” means any synthetically produced polymer material.

The term “cleaning composition” means any paste or powder for cleaning fabric.

The term “impregnate” means to at least partially fill.

### DESCRIPTION OF SELECTED EMBODIMENTS

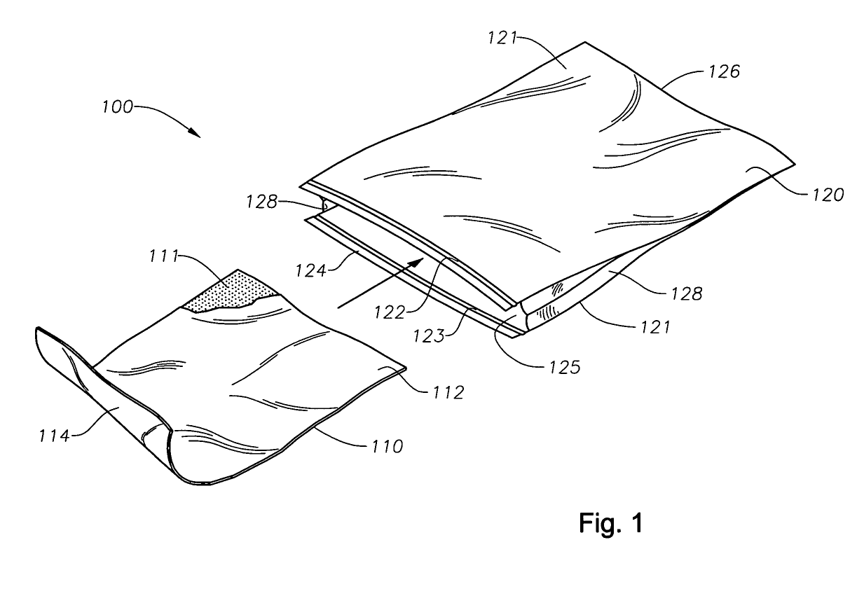

FIG. 1 presents a perspective view of a kit 100 for removing stains from fabric, in one embodiment. The kit 100 includes a pad 110. The pad 110 may be any porous and water absorbent pad that may be stretched or formed to provide a planar surface 112. In the arrangement of FIG. 1, the pad 110 defines a swatch of cloth. The cloth may be fabricated from any water-absorbent fibrous material including, for example, cotton, polyester or any blend thereof. Alternatively, the pad 110 may be a cellulosic material such as fluff pulp. Synthetic materials such as polypropylene may be incorporated for additional structural integrity.

The pad 110 holds a cleaning composition generally 111 in a substantially dry form. Further, the pad 110 is designed to absorb water. The pad 110 must, therefore, be fabricated from a material that will not be adversely affected by the cleaning composition in either its dry or wet state, or by hot water when water is later contacted with the pad 110.

One preferred pad 110 is a Webril® cotton pad manufactured by BBA Nonwovens Simpsonville, Inc. BBA Nonwovens does business out of Simpsonville, S.C. The preferred Webril® pad has a thickness of 65 millimeters and, in a 12″ length×12″ width geometry, is capable of absorbing 10 grams of water. However, other pads and other dimensions of pads may be employed.

The kit 100 also includes a water-impermeable container 120 to hold the pad 110. In the arrangement of FIG. 1, the container 120 defines a transparent bag. The bag 120 is preferably fabricated from a sturdy but lightweight plastic material such as polyethylene or polypropylene. The bag 120 includes a bottom 126, a top 124, two opposing walls 121 and an interior chamber 125. The chamber 125 is accessed through the top end 124 by moving the two opposing walls 121 apart. In this respect, the bag 120 may be expandable by folds 128 connecting the opposing walls 121. The folds 128 and walls 121 are preferably connected by heat sealing.

The container 120 has a sealing means. In the illustrated embodiment, the seal is effected by a zip-lock arrangement. A male strip 122 is fabricated along one wall 121 and is configured to be received into an elongated female channel 123 on the opposing wall 121. In this way, a substantially air-tight seal may be provided. Other sealing means may be employed, such as a heat seal that is later cut open by the consumer, or a perforated seam.

The bag 120 is dimensioned to receive the pad 110. In one embodiment, the bag 120 is 5″ wide×7″ long, while the pad 110 is 4″×6″. Thus, the bag 120 is preferably only slightly larger than the folded or layered pad in order to save material and space. The pad 110 may be a larger swatch of cloth such as 8″×12″ or 12″×12″ that is suitably folded to form the smaller geometry such as 4″×6″ for being received within the container 120. Alternatively, the pad 110 may be comprised of a series of layers sewn or quilted on top of each other to form a thicker 4″×6″ geometry. Preferably, the pad is 12″×12″ and is folded over once to conserve retail space, with the dry cleaning composition being impregnated into the fibers. The edges of the pad may be stitched, quilted, heat sealed or adhered together.

The pad 110 holds a cleaning composition impregnated onto or within the pad 110. The cleaning composition may be a dry powder or may be a flowable anhydrous paste. Preferably, the cleaning composition contains a surfactant, a bleach and one or more enzymes. The cleaning composition dissolves in water to form a liquid surfactant that is held by the absorbent pad 110. The cleaning composition reacts with stain materials on synthetic fibers to remove the stain materials.

The cleaning composition is preferably capable of removing a variety of stains from synthetic fabrics including biological materials, water-based stains, and oil-based stains. Examples of stains that may be removed include mud, grass, blood, mammalian feces, urine, mustard, spaghetti sauce, milk, red wine, coffee, olive oil, tomato juice, grape juice, meat juices, cocoa and lipstick. The composition should not be applied to a wool or a silk fabric.

As noted, the cleaning composition includes a surfactant. Surfactants may be categorized as either hydrophobic or hydrophilic. Hydrophobic surfactants possess an HLB (Hydrophile Lipophile Balance) value of less than 10, while hydrophilic surfactants possess an HLB value of 10 or greater. Those of ordinary skill in the art will understand that the HLB index is the ratio of the lipophilic functionalities to the hydrophilic functionalities within the surfactant.

It is preferred that the dry cleaning composition employ both a hydrophobic surfactant and a hydrophilic surfactant. In one aspect, the hydrophobic surfactant is an alcohol ethoxylate such as primary alcohol ethoxylate, secondary alcohol ethoxylate, ternary alcohol ethoxylate, primary amine ethoxylate, or secondary amine ethoxylate. More specific and nonlimiting examples of surfactants having an HLB value from 1 to 10 include alkyl polysaccharides, alkylamine ethoxylates, block copolymers, castor oil ethoxylates, ceto-oleyl alcohol ethoxylates, ceto-stearyl alcohol ethoxylates, decyl alcohol ethoxylates, end-capped ethoxylates, ethoxylated alkanolamides, fatty alcohol alkoxylates, lauryl alcohol ethoxylates, mono-branched alcohol ethoxylates, synthetic alcohol ethoxylates, tall oil fatty acid ethoxylates and tallow amine ethoxylates.

It is preferred that a linear ethoxylated alcohol be used as a surfactant in the cleaning composition. Tomah Products, Inc. of Milton, Wis. manufactures a line of such surfactants under the trade name Tomadol™. Such products include Tomadol 91-2.5™, which is a nonionic surfactant made from linear C9-11 alcohol with 2.5 or 2.7 moles of ethylene oxide. This Tomadol™ product is merely illustrative; other hydrophobic surfactants may be employed such as Tomadol 1-3™ (HLB 8.7), Tomadol 25-3™ (HLB 7.5), Tomadol 23-1™ (HLB 3.7), Surfonic L24-2™ (HLB 6.2), Surfonic L241.3™ (HLB 4.5), and Condea Vista 6-1EO-1PO™ (HLB 4.3). Surfonic products are commercially available from Huntsman Chemical Company of Houston, Tex. Condea Vista products are commercially available from Condea Vista, Inc. also of Houston, Tex. The hydrophobic surfactants may be present in the composition from 5 to 40 wt % or 10 to 20 wt %.

Surfactants with an HLB value greater than 10 may be added to the cleaning composition. These may again include ethoxylated alcohol surfactants or nonionic surfactants.

Tomah Products' Tomadol™ line of surfactants includes suitable hydrophilic surfactants such as Tomadol 91-6™. Tomadol 91-6™ is a nonionic surfactant made from linear C9-11 alcohol with 6 or 8 moles of ethylene oxide. Tomadol 91-6™ has an HLB of 12.4, and may be used in combination with the lower HLB nonionic surfactant Tomadol 91-2.5™. In one aspect, Tomadol 91-6 (Linear Alcohol Ethoxylate C9-11 6 or 8 EO) and Tomadol 91-2.5™ (Linear Alcohol Ethoxylate C9-11 2.5 EO) are each used. Each of these products demonstrates good biodegradability. The hydrophilic surfactants may be present in the composition from 10 to 50 wt % or 20 to 30 wt %.

In one aspect, the composition employs two nonionic surfactants—one for detergency and the other to promote wetting action and reduce interfacial surface tension, and one anionic surfactant. These may be, for example, C9-11 8 EO Linear Alcohol Ethoxylate and C9-11 2.5 EO Linear Alcohol Ethoxylate. However, anionic hydrophilic surfactants may also be used such as dodecylbenzene-sulfonic acid, sodium dodecylbenzene sulfonate, potassium dodecylbenzene sulfonate, triethanolamine dodecylbenzene sulfonate, disopropylamine decyldiphenyloxide disulfonate, sodium hexadecyloxy-poly(ethyleneoxy) (10)ethyl sulfonate, potassium octylphenoxy poly(ethyleneoxy)(9)ethyl sulfonate, sodium C₁₂₋₁₄ olefin sulfonate, sodium hexadecane-1 sulfonate, sodium ethyl oleate sulfonate, potassium laurate, sodium lauryl sulfate, diethanolamine lauryl sulfate, sodium laureth (3) sulfate, and ammonium laureth (2) sulfate.

The cleaning composition may next include a bleaching agent. The bleach may be of any type including but not limited to chlorine-based and oxygen-based bleaches. An example of a preferred bleach is the oxygen bleach, sodium percarbonate. Sodium percarbonate is a free-flowing powder with a common name of solid hydrogen peroxide. Sodium percarbonate dissolves into water rapidly to release oxygen. It is considered effective and environmentally safe. Preferably, sodium percarbonate is provided in the cleaning composition at 20 to 50 wt. %.

The cleaning composition will preferably also include a detergent builder to increase the cleaning power of the composition. Useful builders include the polyphosphates such as sodium tripolyphosphate and tetrasodium pyrophosphate. Builders may also be organic, such as sodium carbonate, sodium bicarbonate, trisodium nitrilotriacetate, sodium sesquicarbonate, sodium silicate, sodium citrate and sodium gluconate. Builders may further include borax and other borates such as zeolites and polyacetal carboxylates. Other builders known in the detergent art may alternately be employed, and mixtures of builders may also be utilized.

In a preferred composition, both sodium citrate and sodium gluconate are provided to serve as builders and as water conditioners. Sodium citrate is used, for example, at 5 to 20 wt. %, while sodium gluconate is for example, 3 to 15 wt. % of the total cleaning composition.

The cleaning composition also preferably includes a thickening or binding agent. A suitable and nonlimiting example of a binding agent is an ester terminated polyamide, such as polyalkyleneoxy-terminated polyamide resin. Another example of a binding agent is Sylvagel 1000™ manufactured by Arizona Chemical of Jacksonville, Fla. Preferably, the thickening agent is provided at 0.5 to 10 wt. %.

It is also desirable for the cleaning composition to include an enzyme. It is known to provide enzymes as an additive to cleaning detergents. Enzymes act to improve the cleaning effect of the detergent by attacking soil and stains. Enzymes are commercially supplied in the form of a powder or prills, which are small round or acicular aggregates of an enzyme.

Some enzymes are referred to as hydrolases. Hydrolases include, but are not limited to, proteases (which digest proteinaceous substrates), amylases (also known as carbohydrases, which digest carbohydrates), lipases (also known as esterases, which digest fats), cellulases (which digest cellulosic polysaccharides), and mixtures thereof. Preferably, a prilled enzyme is provided at approximately 1.0 wt. %. More preferably, a protease of peroxygen stable protease is used.

It is also desirable to employ a cleaning composition that will not remove dyes within the synthetic fabric material. Thus, the cleaning composition utilized in the kit 100 may further include an anti-dye transfer polymer. Such a polymer operates by complexing with any dye that may leach into the moist pad 110 during the stain removal process. The anti-dye transfer polymer forms a water soluble complex which has a much lower affinity for textile fibers than does the dye molecule alone, and so holds the dye in solution and prevents it from transferring to the absorbent pad 110 and causing discoloration. Examples of such materials are polyvinylpyrolidone, polypyridine-N-oxide, polyvinylimidazole and copolymers of these materials. However, when using an oxygen-based bleaching agent, it is not anticipated that an anti-dye transfer polymer will be needed.

In one embodiment, a general formula for the composition is:

| | |
|---|---|
| Nonionic Surfactants | 0.0-40.0% |
| Anionic Surfactant | 0.0-40.0% |
| Polyalkyleneoxy-terminated Polyamide Resin | 0.5-10.0% |
| Water Conditioner/Builder | 0.0-20.0% |
| Sodium Percarbonate or Sodium Perborate | 0.0-40.0% |
| Peroxygen Stable Protease | 0.0-1.0% |
| Fragrance Oil | 0.0-5.0% |

with all percentages being by weight of the total paste composition.

A more specific example of a formula for the composition is:

| | |
|---|---|
| C9-11 8 EO Linear Alcohol Ethoxylate | 25.0% |
| C9-11 2.5 EO Linear Alcohol Ethoxylate | 15.0% |
| Polyalkyleneoxy-terminated Polyamide Resin | 2.5% |
| Sodium Gluconate | 6.0% |
| Sodium Citrate | 11.0% |
| Sodium Percarbonate | 37.0% |
| Peroxygen Stable Protease | 1.0% |
| Fragrance Oil | 2.5% |

Another even more specific formula for the cleaning composition is:

| | |
|---|---|
| Tomadol 91-6 ™ | 25.0% |
| Tomadol 91-2.5 ™ | 15.0% |
| Sylvagel 1000 ™ | 2.5% |
| Sodium Citrate | 11.0% |
| Sodium Gluconate | 6.0% |
| Sodium Percarbonate | 37.5% |
| Prilled Enzyme | 1.0% |
| Fragrance | 2.5% |

with all percentages being by weight of the total paste composition.

Referring again to the pad 110 of FIG. 1, the pad 110 is rolled through a bed of the cleaning composition 111 to provide the desired level of impregnation. The pad 110 is then inserted into the dry container 120 for sealing and later transport and sale.

Labeling may be provided on the outside of one or both walls 121 of the container 120. Labeling would provide any desired product identification and branding. It may also provide use instructions. The printed material may be affixed to the walls 121 such as by gummed paper or by layers of paper laminated onto the walls 121.

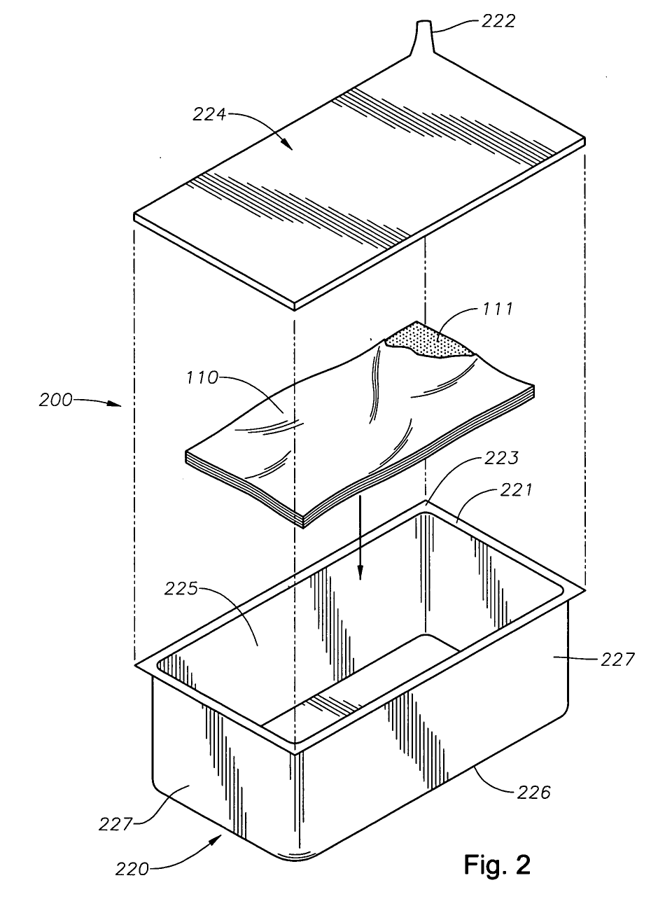

FIG. 2 provides a stain removal kit 200, in an alternate embodiment. The kit 200 once again includes the water-absorbent pad 110 and a water-impermeable container 220. The pad 110 is impregnated with the substantially dry cleaning composition 111, as discussed above. In the illustrative arrangement of FIG. 2, the absorbent pad 110 is a multi-layered cloth that includes cotton fibers.

The container 200 is a plastic tray with a base 226 and side walls 227. The base 226 and side walls 227 define an interior chamber 225 dimensioned to receive the pad 210. In addition, the chamber 225 is dimensioned to receive a volume of heated water sufficient to allow the pad 210 to be fully saturated. In the illustrated embodiment, the tray 220 holds two cups of water. In addition, the tray 200 includes an upper lip surface 221. The upper lip surface 221 receives a cover 224.

The cover 224 is preferably fabricated from a cellulosic material that is substantially water impermeable. The cover 224 is dimensioned to be received onto the upper lip surface 221. The cover 224 sealingly attaches to the upper lip surface such as by a pressure-sensitive adhesive or a gummed strip (not shown). A flap 222 is preferably provided on the cover 224 to aid in removing the cover 224 from the container 220. The flap 222 generally aligns with corner 223 of the container 220.

A method for removing a stain from a synthetic material is also provided. The method uses a stain removal kit such as kits 100 or 200. For purposes of illustration, the method will be described primarily with reference to kit 100. However, it is understood that the method may be utilized with other embodiments such as kit 200.

In operation, a water-impermeable container such as bag 120 is provided. The bag 120 is readily opened, such as at an end 124. The bag 120 is fabricated from a flexible, transparent material such as polyethylene, polyvinyl or other material. The material is preferably substantially gas and vapor proof, and must not be adversely affected by contact with a dry cleaning composition 111. In addition, the material must be of sufficient thickness and durability as to receive and hold water that has been heated to temperatures ranging from about 110° to about 230° F. for a period of up to about ten minutes. Stated another way, the bag or other container 120 must be impervious to the soapy liquid formed when heated water is added into the chamber 125 and held for a sufficient length of time to be absorbed into the pad 110 and to react with the cleaning composition 111. In addition, the material must not contaminate or react with the soapy liquid.

The bag 120 is opened so as to provide access to the chamber 125 and the pad 110 therein. This is accomplished in the illustrated embodiment by separating the male strip 122 and the female channel 123. Heated water is then poured into the bag 120 with the impregnated pad 110 remaining therein. The water may be tap water or distilled water. The water is allowed to sit in the bag 120 for a period of time sufficient to allow the pad 110 to be fully saturated. A further period of time is provided to allow the cleaning composition to dissolve. Preferably, a time of about 2 to 10 minutes is employed.

Next, the saturated pad 110 is removed from the bag 120. The pad 110 is stretched so that the substantially planar surface 124 is formed. The surface 124 is then placed in contact with a stained or soiled fabric such as on carpet or upholstery. Advisably, pressure is applied to the pad 110 to better enable the liquefied cleaning composition to interact with the stain on the synthetic fibers of the fabric and the material of the pad 110 to contact the fibers. The pad 110 is left on the fabric for a period of time sufficient to allow the pad 110 to absorb at least a portion of the stain from the fabric. The drying action helps to pull the detergent that has dissolved and absorbed the staining material back up into the pad 110. In one aspect, the pad 110 remains on the stained fabric for a period of 1 to 24 hours. More preferably, the pad 110 remains on the fabric for about 6 to 24 hours or until the pad 110 becomes substantially dry.

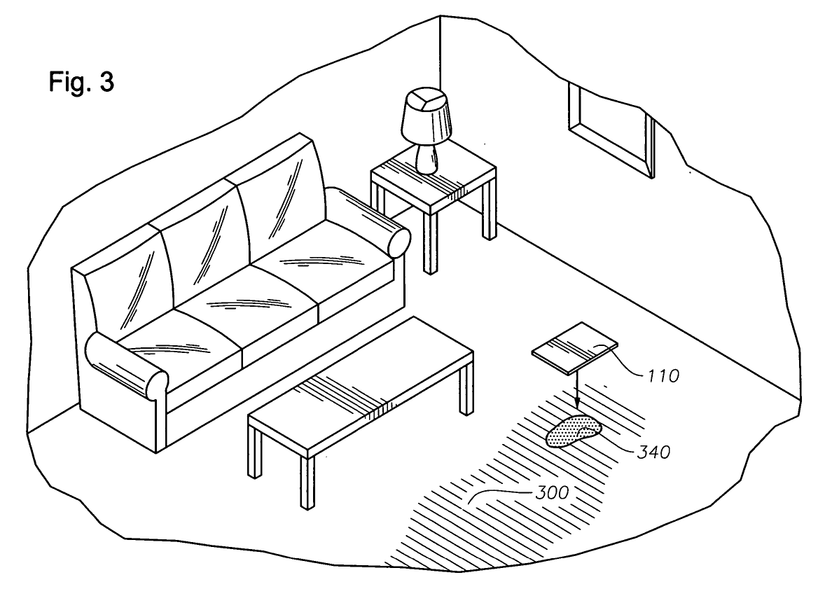

FIG. 3 illustrates the water-saturated pad 110 placed upon a stain 340. The stain 340 is embedded within a section of carpet 300. The liquefied cleaning composition 111 contacts and interacts with the stain or soil 340. When the pad 310 is placed upon the stained area 340, the water-and-cleaner impregnated pad 310 wicks the stain or soil 340 from the carpet 300 and draws it into the absorbent fibers of the pad 110. The synthetic fabric 300 is thereby cleaned and the now-soiled pad 110 is removed from contact with the fabric. The pad 110 is preferably returned to a container, such as container 120 or 220. In the case of bag 120, the bag 120 may be resealed and discarded. It is not recommended that the pad 110 be saved for reuse, although the present invention does not prohibit re-use where the pad 110 is not prohibitively dirty.

It may be desirable to apply pressure to the pad after it is placed onto the stained fabric. This improves contact between the wetted pad and the fibers. However, frictional rubbing is not required, though it is not precluded.

I claim:

1. A method for removing stains from fabric, comprising the steps of:
providing a pad impregnated with a cleaning composition in a substantially dry state within a sealed container;
opening the container;
applying heated water to the pad to produce at least a wetted portion of the pad;
removing the pad from the container;
placing the wetted portion of the pad onto a stained fabric; and
leaving the pad on the fabric for a sufficient period of time to permit at least a portion of the stain to be removed from the fabric.

2. The method of claim 1, wherein the step of impregnating a pad with a cleaning composition comprises rolling at least one surface of the pad through the cleaning composition.

3. The method of claim 1, wherein the step of applying heated water to the pad comprises:
pouring heated water into the container; and
allowing the pad to absorb the heated water until the pad is fully saturated.

4. The method of claim 3, further comprising the step of:
leaving the water in the container for a period of about 2 to about 10 minutes.

5. The method of claim 3, further comprising the step of:
applying pressure to the pad after the pad is placed onto the stained fabric.

6. The method of claim 3, wherein the sufficient period of time is between about 6 and 24 hours.

7. The method of claim 3, wherein the sufficient period of time is until the pad has become substantially dry.

8. The method of claim 4, further comprising the steps of:
removing the pad from the stained fabric after at least a portion of the stain has been removed from the fabric; and
disposing of the pad.

9. The method of claim 1, wherein the pad is a swatch of cotton cloth.

10. The method of claim 1, wherein the cleaning composition comprises:
a surfactant;
a bleach; and
an enzyme.

11. The method of claim 10, wherein the surfactant comprises a nonionic, linear alcohol ethoxylate.

12. The method of claim 10, wherein the bleach is an oxygen bleach.

13. The method of claim 1, wherein the cleaning composition comprises.
a linear alcohol ethoxylate surfactant;
a polyamide thickening agent;
a sodium-based detergent builder and water conditioner;
an oxygen bleach; and
a prilled enzyme.

14. The method of claim 12, wherein the cleaning composition is in the form of an anhydrous paste when the pad is rolled through the cleaning composition.

15. The method of claim 1, wherein the sealed container is a plastic bag.

16. The method of claim 1, wherein the sealed container comprises a plastic tray.

17. A stain removal kit, comprising:
a releasably sealed, water-impermeable container;
a substantially dry, liquid-absorbent pad disposed within the container; and
a cleaning composition carried by the pad.

18. The kit of claim 17, wherein the container is a sealable plastic bag.

19. The kit of claim 18, wherein the bag is sealed by a zip-lock closer.

20. The kit of claim 17, wherein the container is a sealable plastic tray.

21. The kit of claim 20, wherein the tray is sealed by a cellulosic cover.

22. The kit of claim 17, wherein the pad is a swatch of cotton cloth.

23. The kit of claim 17, wherein the cleaning composition comprises
a surfactant;
a bleach; and
an enzyme.

24. The kit of claim 23, wherein the surfactant comprises a linear alcohol ethoxylate surfactant.

25. The kit of claim 23, wherein the bleach is an oxygen bleach.

26. The kit of claim 17, wherein the cleaning composition comprises.
a linear alcohol ethoxylate surfactant;
a polyamide thickening agent;
a sodium-based detergent builder and water conditioner;
an oxygen bleach; and
a prilled enzyme.

27. The kit of claim 17, wherein the cleaning composition is in the form of an anhydrous paste.
